(19) United States
(12) Patent Application Publication
(10) Pub. No.: US 2020/0050276 A1
(43) Pub. Date: Feb. 13, 2020

(54) ELECTRONIC DEVICE, KEYASSEMBLY AND KEY CONTROL METHOD

(71) Applicant: AAC Technologies Pte. Ltd., Singapore city (SG)

(72) Inventor: Xiang Ding, Shenzhen (CN)

(21) Appl. No.: 16/528,698

(22) Filed: Aug. 1, 2019

(30) Foreign Application Priority Data
Aug. 10, 2018 (CN) 201810910816.6

(51) Int. Cl. G06F 3/01; G06F 3/02

(52) U.S. Cl. CPC G06F 3/016; G06F 3/0202

(57) ABSTRACT

The present disclosure relates to the technical field of electronic products, and discloses an electronic device, a key assembly, and a key control method. In the embodiment of the invention, the key assembly includes a key housing, a sensing element, a base, a linear motor and an elastic member. The sensing element is disposed on a surface of the key housing. The key housing is disposed on the base through the elastic member. The linear motor is disposed on the key housing and faces the base. The sensing element and the linear motor are respectively electrically connected to a processor of the electronic device. The processor is configured to acquire a vibration mode corresponding to the sensed data, and control the linear motor to vibrate according to the vibration mode. The embodiment of the present disclosure further provides a key control method and an electronic device.

### TECHNICAL FIELD

The present disclosure relates to the technical field of electronic products, and in particular, to an electronic device, a key assembly, and a key control method.

### BACKGROUND

Most existing key structures on automobiles, keyboards and the like devices are conventional mechanical pressing structures having a large pressing stroke, and an elastic member (for example a spring) is used inside. The elastic member generates deformation and an inverse process when being subjected to an external force (for example, a finger pressing force), so that a user's finger feels press feedback. However, the inventors have found that at least the following problems exist in the related art: the existing key structure directly induces press feedback by finger pressing, which is very mechanic and clumsy; the user can only feel vibration feedback through one type of operation (i.e., pressing); and therefore, the key can only enable the corresponding electronic device to implement one type of function (for example, only the delete function), such that the user cannot control the electronic device through the key to achieve multiple functions, and the different needs of the user cannot be met.

### BRIEF DESCRIPTION OF THE DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic diagram of a key assembly according to a first embodiment;

FIG. 2 is a schematic diagram of an electronic device according to a second embodiment;

FIG. 3 is a schematic diagram of a key control method according to a third embodiment;

FIG. 4 is a schematic diagram of a key control method according to a fourth embodiment; and

FIG. 5 is a schematic diagram of a key control method according to a fifth embodiment.

### DETAILED DESCRIPTION

The present disclosure will be further illustrated with reference to the accompanying drawings and the embodiments.

A first embodiment of the present disclosure relates to a key assembly applied to an electronic device, such as a computer. As shown in FIG. 1, the key assembly includes a key housing 1, a sensing element 2, a base 3, a linear motor 4, and an elastic member 5.

In the present embodiment, the sensing element 2 is disposed on a surface of the key housing 1 and is configured to sense a user's operation on the key housing 1 to generate sensed data. The key housing 1 is disposed on the base 3 through the elastic member 5. The linear motor 4 is disposed on the key housing 1 and faces the base 3. The sensing element 2 and the linear motor 4 are electrically connected to a processor of the electronic device, respectively.

In this embodiment, the processor is configured to receive the sensed data, acquire a vibration mode corresponding to the sensed data, and control the linear motor 4 to vibrate according to the vibration mode. The key housing 1 generates vibration feedback corresponding to the operation in response to the vibration of the linear motor 4. That is, the elastic member 5 provides a vibration space for the linear motor 4.

Compared with the related art, an embodiment of the present disclosure provides a key assembly applied to an electronic device. The key assembly includes a key housing, a base, an elastic member, and a linear motor and a sensing element respectively connected to a processor. The sensing element is disposed on a surface of the key housing. The key housing is disposed on the base through the elastic member. The linear motor is disposed on the key housing and faces the base. The sensing element is configured to generate sensed data when sensing an operation of a user on the key housing. The processor acquires a vibration mode corresponding to the sensed data when receiving the sensed data, and controls the linear motor to vibrate according to the vibration mode. The key housing generates corresponding vibration feedback in response to the vibration of the linear motor, instead of triggering vibration feedback by finger pressing in the related art, improving the smartness and the operation diversity of the key. Moreover, the embodiment of the present disclosure can generate vibration feedback of a corresponding operation according to different operations of the user. The user confirms whether the corresponding operation is completed according to the vibration feedback so that the user can control the electronic device to achieve a variety of functions through different operations on the key, making it convenient for the user to control the electronic device.

The details of the structure of the key assembly of the present embodiment will be specifically described below. The following content is only for the implementation details provided for the convenience of understanding, and is not necessary for implementing the solution.

In one example, the base 3 can be a housing of an electronic device. However, the present disclosure is not limited thereto in practice. The present embodiment does not impose any limitation on the base 3 and can be set according to actual conditions.

In one example, the elastic member 5 may be a spring, an elastic sheet, or the like. The type of the elastic member 5 is not limited in this embodiment.

In one example, the sensing element 2 can be a pressure sensor or a capacitive sensing element. In this embodiment, the type of the sensing element 2 is not limited, and can be set according to actual needs.

In one example, as shown in FIG. 1, the linear motor 4 is disposed in a central region of the key housing 1, so that the linear motor 4 can more easily drive the key housing 1 to move. However, this is merely an exemplary explanation, and the position of the linear motor 4 is not limited in this embodiment.

In one example, there may be a plurality of elastic members 5 provided. The plurality of elastic members 5 is evenly disposed in an edge region of the key housing 1, so that the key housing 1 can be stably supported. However, this is merely an exemplary explanation. This embodiment does not impose any limitation on the number and specific positions of the elastic members 5.

In the present embodiment, there may be one or more linear motors 4 provided. The number of the linear motors 4 is not limited in this embodiment.

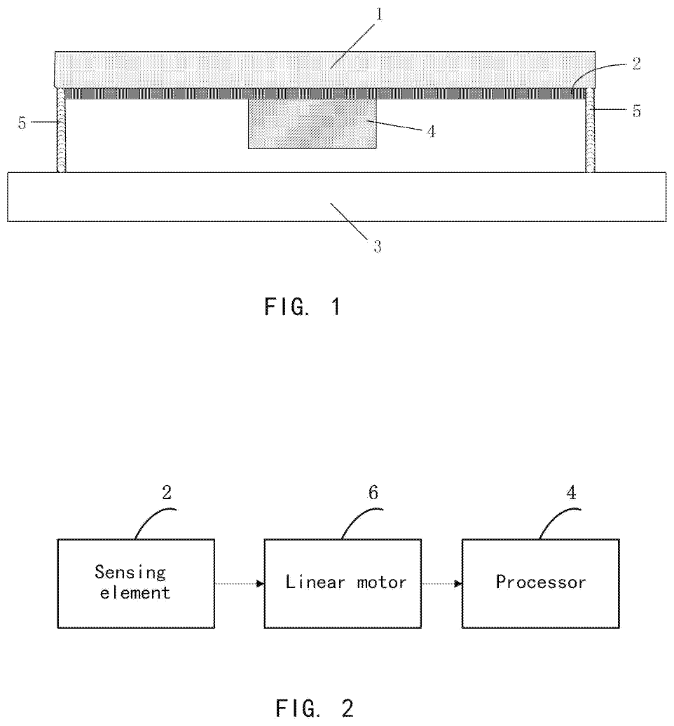

A second embodiment of the present disclosure relates to an electronic device, such as a notebook computer. As shown in FIG. 2, the electronic device includes a key assembly and a processor 6 in the first embodiment. The sensing element 2 and the linear motor 4 in the key assembly are electrically connected to the processor 6 respectively.

Compared to the related art, in this embodiment, the electronic device includes a key assembly provided in the embodiment of the present disclosure. The key assembly includes a key housing, a base, an elastic member, and a linear motor and a sensing element respectively connected to a processor. The key housing is disposed on a surface of the key housing. The key housing is disposed on the base through the elastic member. The linear motor is disposed on the key housing and faces the base. The sensing element is configured to generate sensed data when sensing an operation of a user on the key housing. The processor is configured to, when receiving the sensed data, acquire a vibration mode corresponding to the sensed data, and control the linear motor to vibrate according to the vibration mode. The key housing generates corresponding vibration feedback in response to the vibration of the linear motor, instead of triggering vibration feedback by finger pressing in the related art, improving the smartness and the operation diversity of the key. The embodiment of the present disclosure can generate vibration feedback of a corresponding operation according to different operations of the user. The user confirms whether the corresponding operation is completed according to the vibration feedback so that the user can control the electronic device to achieve a variety of functions through different operations on the key, making it convenient for the user to control the electronic device.

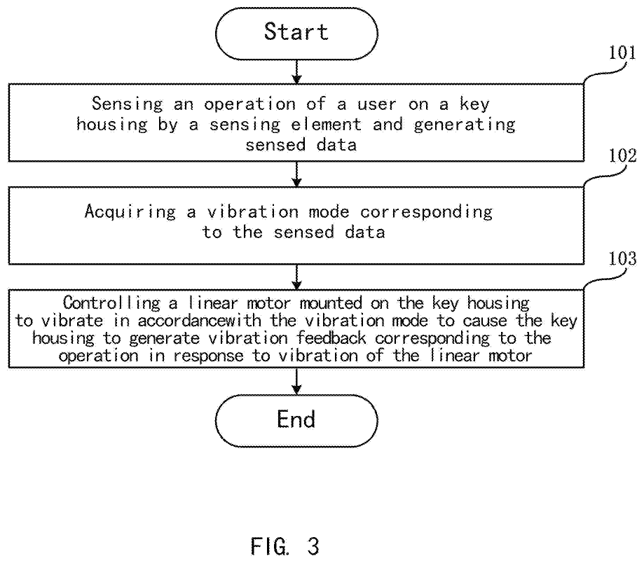

A third embodiment of the present disclosure relates to a key control method applied to a processor of an electronic device in the second embodiment. As shown in FIG. 3, the key control method includes the following steps.

In step 101, an operation of a user on a key housing is sensed by a sensing element, and sensed data is generated.

In this embodiment, the sensing element is disposed on a surface of the key housing, and the key housing is disposed on a base through an elastic member.

In one example, the sensing element may be a pressure sensor or a capacitive sensing element. The embodiment does not impose any limitation on the type of the sensing element, which may be set according to actual needs.

In one example, the sensed data includes one or any combination of pressure information, a touch area, a number of touch points, a sliding direction and a number of touches of the operation by the user. The embodiment does not impose any limitation on the type of the sensed data.

In step 102, a vibration mode corresponding to the sensed data is acquired.

In this embodiment, a preset correlation between the sensed data and the vibration mode is pre-stored in the processor. Therefore, the processor acquires the vibration mode corresponding to the sensed data according to the sensed data and the preset correlation between the sensed data and the vibration mode.

In this embodiment, the vibration mode includes one or a combination of the vibration intensity and the number of vibrations. The embodiment does not impose any limitation on the vibration mode.

In step 103, a linear motor mounted on the key housing is controlled to vibrate according to the vibration mode to cause the key housing to generate corresponding vibration feedback in response to the vibration of the linear motor.

In the present embodiment, the operation of the user on the key housing, the vibration mode, and the vibration feedback correspond to each other.

The embodiment of the present disclosure provides a key control method for controlling a key assembly provided by the embodiment of the present disclosure. That is, when an operation of a user on a key housing is sensed by a sensing element, the sensing element generates sensed data, acquires a vibration mode corresponding to the sensed data, and controls a linear motor to vibrate according to the vibration mode, so that the key housing generates corresponding vibration feedback in response to the vibration of the linear motor. That is, the embodiment of the present disclosure can generate vibration feedback for a corresponding operation according to different operations of the user. The user confirms whether the corresponding operation is completed according to the vibration feedback, so that the user can control the electronic device to achieve various functions by different operations on the key, thereby making it convenient for the user to control the electronic device.

A fourth embodiment of the present disclosure relates to a key control method. The fourth embodiment is improved on the basis of the third embodiment. The main improvement is that in the fourth embodiment of the present disclosure, a method of acquiring the vibration mode is provided.

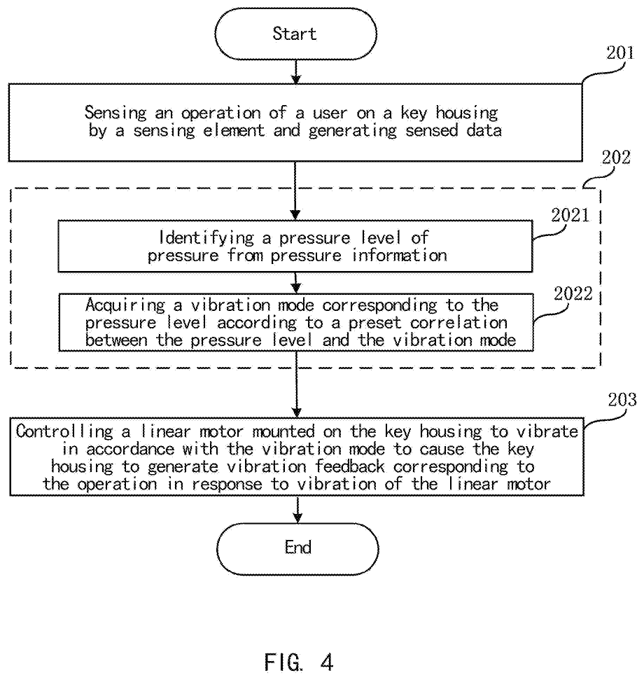

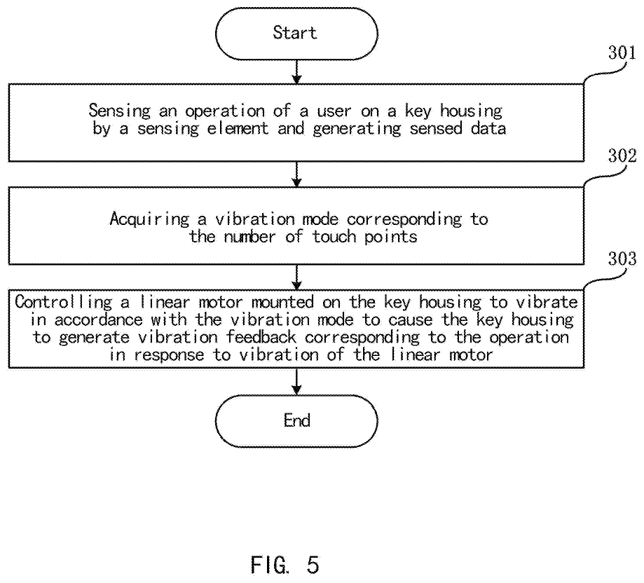

The key control method of the present embodiment is as shown in FIG. 4. Steps 201 and 203 of the present embodiment are the same as steps 101 and 103 of the first embodiment, and step 202 of the present embodiment includes the following sub-steps.

In sub-step 2021, a pressure level of the pressure is identified from the pressure information.

In the present embodiment, when the sensed data is the pressure information, this step is performed. Moreover, a preset correlation between the pressure and the pressure level is pre-stored in the processor. One pressure level corresponds to a plurality of pressure values. In this embodiment, the pressure of the user's operation is identified from the pressure information. The pressure level corresponding to the pressure is identified according to the preset correlation.

In sub-step 2022, a vibration mode corresponding to the pressure level is acquired according to a preset correlation between the pressure level and the vibration mode.

In the present embodiment, when the vibration mode is vibration intensity, the preset correlation is a preset correlation between the pressure level and the vibration intensity. Different vibration intensities control the electronic device to achieve a function of the corresponding intensity. When the vibration mode is the number of vibrations, the preset correlation is a preset correlation between the pressure level and the number of vibrations. Different numbers of vibrations control the electronic device to achieve the function for a corresponding number of times.

In one example, the pre-stored pressure level includes level 1 pressure and level 2 pressure. The level 1 pressure corresponds to level 1 vibration intensity. The level 2 pressure corresponds to level 2 vibration intensity. When the pressure level of the pressure is identified as level 2 pressure, the vibration intensity corresponding to the level 2 pressure is acquired as the level 2 vibration intensity. However, this is merely an exemplary explanation, which is not limited in practice.

Compared with the third embodiment, in the embodiment of the present disclosure, when the sensed data is pressure information, the pressure level of the pressure is identified from the pressure information, and a vibration mode corresponding to the pressure level is acquired according to a preset correlation between the pressure level and the vibration mode, which provides a method of acquiring the vibration mode.

A fifth embodiment of the present disclosure relates to a key control method. The fifth embodiment is improved on the basis of the third embodiment. The main improvement is that in the fifth embodiment of the present disclosure, a method of acquiring the vibration mode is provided.

The key control method of the present embodiment is as shown in FIG. 5. Steps 301 and 303 of the present embodiment are the same as steps 101 and 103 of the first embodiment, and step 302 of the present embodiment is as follows.

In sub-step 302, a vibration mode corresponding to the number of touch points is acquired.

In the present embodiment, when the sensed data is the number of touch points, this step is performed. Further, in the present embodiment, a preset correlation between the number of touch points and the vibration mode is pre-stored.

In one example, the vibration mode is the number of vibrations. It is preset that a single-point touch corresponds to one vibration, and a multi-point touch corresponds to two vibrations. When the number of touch points is two, the acquired corresponding vibration mode is two-vibration. This is merely an illustrative explanation, which is not limited in practice.

Compared to the third embodiment, in the embodiment of the present disclosure, when the sensed data is the number of touch points, a vibration mode corresponding to the number of touch points is acquired, that is, another method of acquiring the vibration mode is provided.

A person skilled in the art can understand that the above embodiments are specific embodiments for implementing the present disclosure, and various changes can be made in the form and details without departing from the spirit and scope of the present disclosure.

What is claimed is:

1. A key assembly applied to an electronic device, comprising:
a key housing;
a sensing element;
a base;
a linear motor; and
an elastic member,
wherein the sensing element is disposed on a surface of the key housing, and is configured to generate sensed data when sensing an operation of a user on the key housing;
the key housing is disposed on the base through the elastic member, and the linear motor is disposed on the key housing and faces the base;
the sensing element and the linear motor are electrically connected to a processor of the electronic device, respectively; and
the processor is configured to receive the sensed data, acquire a vibration mode corresponding to the sensed data, and control the linear motor to vibrate according to the vibration mode, and the key housing generates vibration feedback corresponding to the operation in response to vibration of the linear motor.

2. The key assembly as described in claim 1, wherein the linear motor is disposed in a central region of the key housing.

3. The key assembly as described in claim 1, wherein a plurality of elastic members is provided; and the plurality of elastic members is uniformly disposed at an edge region of the key housing.

4. The key assembly as described in claim 1, wherein the sensing element is a pressure sensor or a capacitive sensing element.

5. The key assembly as described in claim 1, wherein the elastic member is a spring or an elastic sheet.

6. An electronic device, comprising:
a key assembly; and
a processor as described in claim 1,
wherein the sensing element in the key assembly and the linear motor are electrically connected to the processor, respectively.

7. The electronic device as described in claim 6, wherein the linear motor is disposed in a central region of the key housing.

8. The electronic device as described in claim 6, wherein a plurality of elastic members is provided; and the plurality of elastic members is uniformly disposed at an edge region of the key housing.

9. The electronic device as described in claim 6, wherein the sensing element is a pressure sensor or a capacitive sensing element.

10. The electronic device as described in claim 6, wherein the elastic member is a spring or an elastic sheet.

11. A key control method, comprising:
sensing an operation of a user on a key housing by a sensing element and generating sensed data; the sensing element being disposed on a surface of the key housing, and the key housing being disposed on a base through an elastic member;
acquiring a vibration mode corresponding to the sensed data; and
controlling a linear motor mounted on the key housing to vibrate in accordance with the vibration mode to cause the key housing to generate vibration feedback corresponding to the operation in response to vibration of the linear motor.

12. The key control method as described in claim 11, wherein the sensed data comprises one or any combination of pressure information, a touch area, a number of touch points, a sliding direction and a number of touches of the operation.

13. The key control method as described in claim 11, wherein when the sensed data is the pressure information, said acquiring the vibration mode corresponding to the sensed data comprises:
identifying a pressure level of pressure from the pressure information; and
acquiring the vibration mode corresponding to the pressure level according to a preset correlation between the pressure level and the vibration mode.

14. The key control method as described in claim 11, wherein the vibration mode comprises one or a combination of vibration intensity and a number of vibrations.
